(19) United States
(12) Patent Application Publication
(10) Pub. No.: US 2020/0126325 A1
(43) Pub. Date: Apr. 23, 2020

(54) ELECTRONIC CONTROL UNIT AND COMMUNICATION DEVICE

(71) Applicant: LG Electronics Inc., Seoul (KR)

(72) Inventors: Chaeul Jeon, Seoul (KR); Dongwook Kim, Seoul (KR); Kgiwung Ryoo, Seoul (KR); Dongwoo Han, Seoul (KR)

(21) Appl. No.: 16/656,092

(22) Filed: Oct. 17, 2019

(30) Foreign Application Priority Data
Oct. 17, 2018 (KR) PCT/KR2018/012264

(51) Int. Cl. G07C 5/00; G07C 5/02; G07C 5/08; H04L 12/927; H04L 12/851; H04L 12/911; H04W 4/48; H04W 4/90

(52) U.S. Cl. CPC G07C 5/008; G07C 5/02; G07C 5/0866; H04W 4/90; H04L 47/24; H04L 47/821; H04W 4/48; H04L 47/805

(57) ABSTRACT

One embodiment of the present invention relates to an electronic control unit mounted in a vehicle. The electronic control unit includes a communication unit to receive electric device information from one or more electric devices disposed in the vehicle, and a processor to select electric device information received from one of the one or more electric devices in response to an event occurrence and to control the communication unit such that the selected electric device information is preferentially transmitted to a server.

### CROSS-REFERENCE TO RELATED APPLICATION

Pursuant to 35 U.S.C. § 119(a), this application claims the benefit of an earlier filing date of and the right of priority to International Application No. PCT/KR2018/012264, filed on Oct. 17, 2018, the contents of which are incorporated by reference herein in its entirety.

### BACKGROUND OF THE DISCLOSURE

### 1. Field of the Disclosure

The present invention relates to an electronic control unit equipped in a vehicle to perform communications with electric devices, and a vehicle having the same. Further, the present invention relates to a communication device for relaying an electronic control unit and a server.

### 2. Background of the Disclosure

A vehicle refers to means of transporting people or goods by using kinetic energy. Representative examples of vehicles include automobiles and motorcycles.

For safety and convenience of a user who uses the vehicle, various sensors and devices are provided in the vehicle, and functions of the vehicle are diversified.

The functions of the vehicle may be divided into a convenience function for promoting driver's convenience, and a safety function for enhancing safety of the driver and/or pedestrians.

First, the convenience function has a development motive associated with the driver's convenience, such as providing infotainment (information+entertainment) to the vehicle, supporting a partially autonomous driving function, or helping the driver ensuring a field of vision at night or at a blind spot. For example, the convenience functions may include various functions, such as an active cruise control (ACC), a smart parking assist system (SPAS), a night vision (NV), a head up display (HUD), an around view monitor (AVM), an adaptive headlight system (AHS), and the like.

The safety function is a technique of ensuring safeties of the driver and/or pedestrians, and may include various functions, such as a lane departure warning system (LDWS), a lane keeping assist system (LKAS), an autonomous emergency braking (AEB), and the like.

As the convenience function and the safety function are applied to the vehicle, an amount of data transmitted/received between an external device located outside the vehicle and an internal device mounted in the vehicle is rapidly increasing. This is because the internal device transmits internal information generated thereby to a server, and the server transmits external information that the internal device can use to the vehicle.

In order to execute the convenience function and the safety function without errors, high-capacity data must be transmitted and received. However, it is a problem that frequency resources allocated to the vehicle are limited. For example, when a passenger plays back a high-quality moving image (or video) which should be received in real time from a server in a situation that a high-quality map should be received in real time for autonomous driving, a failure to receive the high-quality map may occur.

Over the past decade, wireless carriers around the world have increased their network capacities by 20 times, but over the same period, consumers have increased more than 100 times. A 5G mobile network (5G network) with maximum download speed of 20 Gbps and minimum download speed of 100 Mbps by using an ultra-high frequency of 28 GHz is expected to be introduced, but limited frequency resources should be efficiently used in an autonomous vehicle that needs to exchange a large amount of data seamlessly with a server.

### SUMMARY OF THE DISCLOSURE

The present invention is directed to solving the aforementioned problems and other drawbacks.

One aspect of the present invention is to provide an electronic control unit and a communication device capable of efficiently using limited frequency resources. Another aspect of the present invention is to provide an electronic control unit and a communication device, capable of ensuring communications with quality of service (QoS) of a predetermined level or more in various situations.

The present invention relates to an electronic control unit and a communication device. The electronic control unit may be mounted in a vehicle, and include a communication unit to receive electric device information from one or more electric devices disposed in the vehicle, and a processor to select electric device information received from one of the one or more electric devices in response to an event occurrence and to control the communication unit such that the selected electric device information is preferentially transmitted to a server. According to one embodiment, the one electric device information selected by the processor may differ according to the event.

According to one embodiment, the event may correspond to that a collision of a reference value or more occurs in the vehicle, and the one electric device information selected by the processor may differ depending on a collision attribute defined by the collision.

According to one embodiment, the electric devices may include a front camera for generating a front image of the vehicle and a rear camera for generating a rear image of the vehicle. The processor may transmit the front image in preference to the rear image when a front collision accident has occurred as the event, and transmit the rear image to the server in preference to the front image when a rear collision accident has occurred as the event.

According to one embodiment, the processor may change a data transmission order, which has been set before the event occurs, in response to the occurrence of the event, and sequentially transmit the electric device information received from the one or more electric devices according to the changed data transmission order.

According to one embodiment, the processor may process the electric device information received from the one or more electric devices based on the changed data transmission order.

According to one embodiment, the processor may divide one electric device information into at least two pieces of data based on an available bandwidth of the communication unit, and transmit the divided pieces of data to the server at different time points.

According to one embodiment, the processor may divide an available bandwidth of the communication unit into a first bandwidth and a second bandwidth, and transmit the one electric device information using the first bandwidth while transmitting the remaining electric device information other than the one electric device information using the second bandwidth.

According to one embodiment, the first bandwidth may be larger than the second bandwidth.

According to one embodiment, the processor may variably set at least one of the first bandwidth and the second bandwidth according to a time point at which transmission of the one electric device information should be completed.

According to one embodiment, the processor may reset at least one of the first bandwidth and the second bandwidth when the communication unit is connected to an unlicensed band network.

According to one embodiment, the processor may control the communication unit such that the remaining electric device information is transmitted to the server through the unlicensed band network in response to being connected to the unlicensed band network.

According to one embodiment, the processor may classify the electric device information received from the one or more electric devices into a first group and a second group according to a predetermined criterion, in response to the event occurrence. The processor may transmit the electric device information included in the first group to the server and store the electric device information included in the second group in a memory provided in the vehicle.

According to one embodiment, the electric device information included in the second group may have a set available period, and the processor may control the communication unit so that the electric device information included in the second group is transmitted to the server before a lapse of the available period or at a predetermined time point defined in the available period.

Further, the present invention can extend even to a vehicle having the electronic control unit and/or a vehicle control method.

A communication device according to the present invention may relay vehicles and a server located in a predetermined area, and the device may include a communication unit to receive vehicle information from one or more vehicles located in the predetermined area, and a processor to select vehicle information received from any one of the one or more vehicles in response to an event occurrence, and control the communication unit such that the selected vehicle information is preferentially transmitted to the server.

According to one embodiment, the event may correspond to that an emergency vehicle satisfying a reference condition enters the predetermined area, or a vehicle located within the predetermined area changes to the emergency vehicle satisfying the reference condition, and the processor may control the communication unit such that vehicle information received from the emergency vehicle is preferentially transmitted to the server.

According to one embodiment, the reference condition may be that an accident occurs in any vehicle located in the predetermined area, and the processor may classify the vehicle information received from the accident vehicle into a first group and a second group based on an accident attribute defined by the accident, and control the communication unit so that the vehicle information included in the first group is transmitted earlier than the vehicle information included in the second group.

According to one embodiment, the processor may divide an available bandwidth of the communication unit into a first bandwidth and a second bandwidth, and allocate the first bandwidth to the one vehicle and the second bandwidth to the remaining vehicles other than the one vehicle.

According to one embodiment, the processor may transmit to the remaining vehicles a restriction message limiting transmission of vehicle information so that the vehicle information is to not transmitted from the remaining vehicles, in response to the event occurrence.

According to one embodiment, the processor may change a data transmission order set before the event occurs, in response to the occurrence of the event, and sequentially transmit the electric device information received from the one or more electric devices according to the changed data transmission order.

Hereinafter, effects of an electronic control unit and a vehicle having the same according to the present invention will be described.

In a vehicle environment in which high-capacity data is transmitted and received in real time by a plurality of vehicles, important electric device information is selected according to an event that has occurred, and preferentially transmitted to a server, which results in an efficient use of limited frequency resources. In addition, since priorities are set for data to be transmitted and received, communication quality of service (QoS) of data with higher priority is ensured.

### BRIEF DESCRIPTION OF THE DRAWINGS

FIG. 1 is a block diagram illustrating a vehicle in accordance with an embodiment of the present invention.

FIG. 2 is a block diagram illustrating an electronic control unit and a system including the same in accordance with an embodiment of the present invention.

FIG. 3 is a flowchart illustrating an operation of an electronic control unit.

FIGS. 4A and 4B are conceptual views illustrating an embodiment for selecting electric device information to be transmitted to a server due to collision occurred in a vehicle.

FIG. 5 is a flowchart illustrating a method in which an electronic control unit changes a data transmission order of electric device information to be transmitted to a server in accordance with an embodiment of the present invention.

FIG. 6 is a conceptual view illustrating processing of electric device information in the method of FIG. 5.

FIG. 7 is a flowchart illustrating a method in which an electronic control unit divides useable or available bandwidths and independently uses the divided bandwidths in accordance with an embodiment of the present invention.

FIG. 8 is a conceptual view illustrating the method of FIG. 7 in detail.

FIG. 9 is a flowchart illustrating a method in which an electronic control unit preferentially transmits electric device information in accordance with an embodiment of the present invention.

FIG. 10 is a flowchart illustrating an operation of a communication device for relaying vehicles and a server located in a predetermined area.

FIG. 11 is a conceptual view illustrating the operation of FIG. 10 in detail.

FIG. 12 is a flowchart illustrating a method of controlling a communication device in accordance with an embodiment of the present invention.

### DETAILED DESCRIPTION OF THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present invention may be understood as a conception including cars, motorcycles and the like. Hereinafter, the vehicle will be described based on a car.

The vehicle according to the embodiment of the present invention may be a conception including all of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

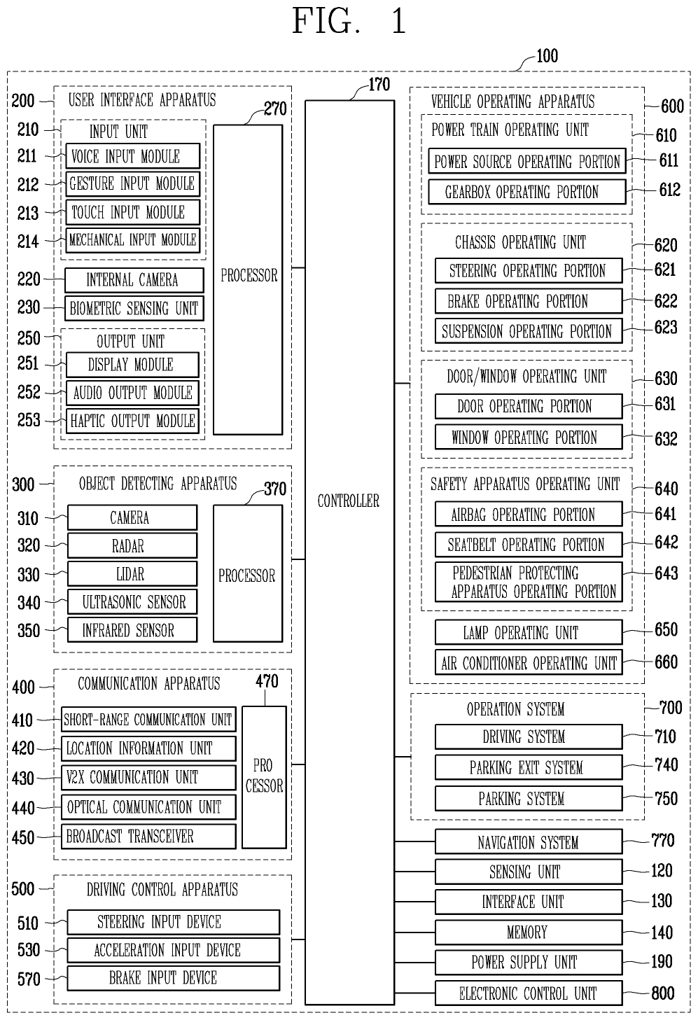

FIG. 1 is a block diagram illustrating a vehicle in accordance with an embodiment of the present invention.

A vehicle 100 may include wheels turning by a driving force, and a steering apparatus 510 for adjusting a driving (ongoing, moving) direction of the vehicle 100.

The vehicle 100 may be an autonomous vehicle.

Here, the autonomous driving is defined as controlling at least one of acceleration, deceleration, and driving direction based on a preset algorithm. In other words, the autonomous driving refers to that a driving control apparatus is automatically manipulated even without a user input applied to the driving control apparatus.

The vehicle 100 may be switched into an autonomous mode or a manual mode based on a user input.

For example, the vehicle may be converted from the manual mode into the autonomous mode or from the autonomous mode into the manual mode based on a user input received through a user interface apparatus 200.

The vehicle 100 may be switched into the autonomous mode or the manual mode based on driving environment information. The driving environment information may be generated based on object information provided from an object detecting apparatus 300.

For example, the vehicle 100 may be switched from the manual mode into the autonomous mode or from the autonomous module into the manual mode based on driving environment information generated in the object detecting apparatus 300.

In an example, the vehicle 100 may be switched from the manual mode into the autonomous mode or from the autonomous module into the manual mode based on driving environment information received through a communication apparatus 400.

The vehicle 100 may be switched from the manual mode into the autonomous mode or from the autonomous module into the manual mode based on information, data or signal provided from an external device.

When the vehicle 100 is driven in the autonomous mode, the autonomous vehicle 100 may be driven based on an operation system 700.

For example, the autonomous vehicle 100 may be driven based on information, data or signal generated in a driving system 710, a parking exit system 740 and a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100.

As illustrated in FIG. 1, the vehicle 100 may include a user interface apparatus 200, an object detecting apparatus 300, a communication apparatus 400, a driving control apparatus 500, a vehicle operating apparatus 600, an operation system 700, a navigation system 770, a sensing unit 120, an interface unit 130, a memory 140, a controller 170 and a power supply unit 190.

According to embodiments, the vehicle 100 may include more components in addition to components to be explained in this specification or may not include some of those components to be explained in this specification.

The user interface apparatus 200 is an apparatus for communication between the vehicle 100 and a user. The user interface apparatus 200 may receive a user input and provide information generated in the vehicle 100 to the user. The vehicle 200 may implement user interfaces (UIs) or user experiences (UXs) through the user interface apparatus 200.

The user interface apparatus 200 may include an input unit 210, an internal camera 220, a biometric sensing unit 230, an output unit 250 and a processor 270.

According to embodiments, the user interface apparatus 200 may include more components in addition to components to be explained in this specification or may not include some of those components to be explained in this specification.

The input unit 210 may allow the user to input information. Data collected in the input unit 200 may be analyzed by the processor 270 and processed as a user's control command.

The input unit 210 may be disposed inside the vehicle. For example, the input unit 200 may be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 210 may include a voice input module 211, a gesture input module 212, a touch input module 213, and a mechanical input module 214.

The audio input module 211 may convert a user's voice input into an electric signal. The converted electric signal may be provided to the processor 270 or the controller 170.

The voice input module 211 may include at least one microphone.

The gesture input module 212 may convert a user's gesture input into an electric signal. The converted electric signal may be provided to the processor 270 or the controller 170.

The gesture input module 212 may include at least one of an infrared sensor and an image sensor for detecting the user's gesture input.

According to embodiments, the gesture input module 212 may detect a user's three-dimensional (3D) gesture input. To this end, the gesture input module 212 may include a light to emitting diode outputting a plurality of infrared rays or a plurality of image sensors.

The gesture input module 212 may detect the user's 3D gesture input by a time of flight (TOF) method, a structured light method or a disparity method.

The touch input module 213 may convert the user's touch input into an electric signal. The converted electric signal may be provided to the processor 270 or the controller 170.

The touch input module 213 may include a touch sensor for detecting the user's touch input.

According to an embodiment, the touch input module 213 may be integrated with the display module 251 so as to implement a touch screen. The touch screen may provide an input interface and an output interface between the vehicle 100 and the user.

The mechanical input module 214 may include at least one of a button, a dome switch, a jog wheel and a jog switch. An electric signal generated by the mechanical input module 214 may be provided to the processor 270 or the controller 170.

The mechanical input module 214 may be arranged on a steering wheel, a center fascia, a center console, a cockpit module, a door and the like.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing module 230 may include a sensor for detecting the user's biometric information and acquire fingerprint information and heart rate information regarding the user using the sensor. The biometric information may be used for user authentication.

The output unit 250 may generate an output related to a visual, audible or tactile signal.

The output unit 250 may include at least one of a display module 251, an audio output module 252 and a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a thin film electroluminescent (TFEL), a transparent OLED, a transparent LCD, a transmissive transparent display and a transparent LED display. The transparent display may have adjustable transparency.

Meanwhile, the user interface apparatus 200 may be provided with a plurality of display modules.

The display modules may be disposed on one area of a steering wheel, one area of an instrument panel, one area of a seat, one area of each pillar, one area of a door, one area of a center console, one area of a headlining or one area of a sun visor, or implemented on one area of a windshield or one area of a window.

The audio output module 252 converts an electric signal provided from the processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user can recognize such output.

The processor 270 may control an overall operation of each unit of the user interface apparatus 200.

According to an embodiment, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

Meanwhile, the user interface apparatus 200 may be called as a display apparatus for vehicle.

The user interface apparatus 200 may operate according to the control of the controller 170.

The object detecting apparatus 300 is an apparatus for detecting an object located at outside of the vehicle 100.

The object may be a variety of objects associated with driving (operation) of the vehicle 100.

The object may include a lane, another vehicle, a pedestrian, a motorcycle, a traffic signal, a light, a road, a structure, a speed limiter, a landmark, an animal, and the like.

The lane may be a driving lane, a lane next to the driving lane or a lane on which another vehicle comes in an opposite direction to the vehicle 100. The lanes may be a concept including left and right lines forming a lane.

The another vehicle may be a vehicle which is moving around the vehicle 100. The another vehicle OB11 may be a vehicle located within a predetermined distance from the vehicle 100. For example, the another vehicle may be a vehicle which moves before or after the vehicle 100.

The pedestrian may be a person located near the vehicle 100. The pedestrian may be a person located within a predetermined distance from the vehicle 100. For example, the pedestrian may be a person located on a sidewalk or roadway.

The two-wheeled vehicle may refer to a vehicle (transportation facility) that is located near the vehicle 100 and moves using two wheels. The two-wheeled vehicle may be a vehicle that is located within a predetermined distance from the vehicle 100 and has two wheels. For example, the two-wheeled vehicle may be a motorcycle or a bicycle that is located on a sidewalk or roadway.

The traffic signals may include a traffic light, a traffic sign and a pattern or text drawn on a road surface.

The light may be light emitted from a lamp provided on another vehicle. The light may be light generated from a streetlamp. The light may be solar light.

The road may include a road surface, a curve, an upward slope, a downward slope and the like.

The structure may be an object that is located near a road and fixed on the ground. For example, the structure may include a streetlamp, a roadside tree, a building, an electric pole, a traffic light, a bridge and the like.

The terrain may include a mountain, a hill and the like.

Meanwhile, objects may be classified into a moving object and a fixed object. For example, the moving object may be a concept including another vehicle and a pedestrian. The fixed object may be a concept including a traffic signal, a road and a structure, for example.

The object detecting apparatus 300 may include a camera 310, a radar 320, a LiDAR 330, an ultrasonic sensor 340, an infrared sensor 350 and a processor 370.

According to an embodiment, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an around view monitoring (AVM) camera 310b or a 360-degree camera.

For example, the camera 310 may be disposed adjacent to a front windshield within the vehicle to acquire a front image of the vehicle. Or, the camera 310 may be disposed adjacent to a front bumper or a radiator grill.

For example, the camera 310 may be disposed adjacent to a rear glass within the vehicle to acquire a rear image of the vehicle. Or, the camera 310 may be disposed adjacent to a rear bumper, a trunk or a tail gate.

For example, the camera 310 may be disposed adjacent to at least one of side windows within the vehicle to acquire a side image of the vehicle. Or, the camera 310 may be disposed adjacent to a side mirror, a fender or a door.

The camera 310 may provide an acquired image to the processor 370.

The radar 320 may include electric wave transmitting and receiving portions. The radar 320 may be implemented as a pulse radar or a continuous wave radar according to a principle of emitting electric waves. The radar 320 may be implemented in a frequency modulated continuous wave (FMCW) manner or a frequency shift Keyong (FSK) manner according to a signal waveform, among the continuous wave radar methods.

The radar 320 may detect an object in a time of flight (TOF) manner or a phase-shift manner through the medium of the electric wave, and detect a position of the detected object, a distance from the detected object and a relative speed with the detected object.

The radar 320 may be disposed on an appropriate position outside the vehicle for detecting an object which is located at a front, rear or side of the vehicle.

The LiDAR 330 may include laser transmitting and receiving portions. The LiDAR 330 may be implemented in a time of flight (TOF) manner or a phase-shift manner.

The LiDAR 330 may be implemented as a drive type or a non-drive type.

For the drive type, the LiDAR 330 may be rotated by a motor and detect object near the vehicle 100.

For the non-drive type, the LiDAR 330 may detect, through light steering, objects which are located within a predetermined range based on the vehicle 100. The vehicle 100 may include a plurality of non-drive type LiDARs 330.

The LiDAR 330 may detect an object in a TOP manner or a phase-shift manner through the medium of a laser beam, and detect a position of the detected object, a distance from the detected object and a relative speed with the detected object.

The LiDAR 330 may be disposed on an appropriate position outside the vehicle for detecting an object located at the front, rear or side of the vehicle.

The ultrasonic sensor 340 may include ultrasonic wave transmitting and receiving portions. The ultrasonic sensor 340 may detect an object based on an ultrasonic wave, and detect a position of the detected object, a distance from the detected object and a relative speed with the detected object.

The ultrasonic sensor 340 may be disposed on an appropriate position outside the vehicle for detecting an object located at the front, rear or side of the vehicle.

The infrared sensor 350 may include infrared light transmitting and receiving portions. The infrared sensor 340 may detect an object based on infrared light, and detect a position of the detected object, a distance from the detected object and a relative speed with the detected object.

The infrared sensor 350 may be disposed on an appropriate position outside the vehicle for detecting an object located at the front, rear or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave which an emitted electromagnetic wave is reflected from the object, and track the object. The processor 370 may execute operations, such as a calculation of a distance from the object, a calculation of a relative speed with the object and the like, based on the electromagnetic wave.

The processor 370 may detect an object based on a reflected laser beam which an emitted laser beam is reflected from the object, and track the object. The processor 370 may execute operations, such as a calculation of a distance from the object, a calculation of a relative speed with the object and the like, based on the laser beam.

The processor 370 may detect an object based on a reflected ultrasonic wave which an emitted ultrasonic wave is reflected from the object, and track the object. The processor 370 may execute operations, such as a calculation of a distance from the object, a calculation of a relative speed with the object and the like, based on the ultrasonic wave.

The processor may detect an object based on reflected infrared light which emitted infrared light is reflected from the object, and track the object. The processor 370 may execute operations, such as a calculation of a distance from the object, a calculation of a relative speed with the object and the like, based on the infrared light.

According to an embodiment, the object detecting apparatus 300 may include a plurality of processors 370 or may not include any processor 370. For example, each of the camera 310, the radar 320, the LiDAR 330, the ultrasonic sensor 340 and the infrared sensor 350 may include the processor in an individual manner.

When the processor 370 is not included in the object detecting apparatus 300, the object detecting apparatus 300 may operate according to the control of a processor of an apparatus within the vehicle 100 or the controller 170.

The object detecting apparatus 300 may operate according to the control of the controller 170.

The communication apparatus 400 is an apparatus for performing communication with an external device. Here, the external device may be another vehicle, a mobile terminal or a server. The communication device 400 may be referred to as a ‘wireless communication unit’.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a processor 470.

According to an embodiment, the communication apparatus 400 may further include other components in addition to the components described, or may not include some of the components described.

The short-range communication unit 410 is a unit for facilitating short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communications with a server (Vehicle to Infra; V2I), another vehicle (Vehicle to Vehicle; V2V), or a pedestrian (Vehicle to Pedestrian; V2P). The V2X communication unit 430 may include an RF circuit implementing a communication protocol with the infra (V2I), a communication protocol between the vehicles (V2V) and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

According to an embodiment, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal and a data broadcast signal.

The processor 470 may control an overall operation of each unit of the communication apparatus 400.

According to an embodiment, the communication apparatus 400 may include a plurality of processors 470 or may not include any processor 470.

When the processor 470 is not included in the communication apparatus 400, the communication apparatus 400 may operate according to the control of a processor of another device within the vehicle 100 or the controller 170.

Meanwhile, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

The communication apparatus 400 may operate according to the control of the controller 170.

The driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding a driving (ongoing) direction of the vehicle 100 from the user. The steering input device 510 is preferably configured in the form of a wheel allowing a steering input in a rotating manner. According to some embodiments, the steering input device may also be configured in a shape of a touch screen, a touch pad or a button.

The acceleration input device 530 may receive an input for accelerating the vehicle 100 from the user. The brake input device 570 may receive an input for braking the vehicle 100 from the user. Each of the acceleration input device 530 and the brake input device 570 is preferably configured in the form of a pedal. According to some embodiments, the acceleration input device or the brake input device may also be configured in a shape of a touch screen, a touch pad or a button.

The driving control apparatus 500 may operate according to the control of the controller 170.

The vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some embodiments, the vehicle operating apparatus 600 may further include other components in addition to the components described, or may not include some of the components described.

Meanwhile, the vehicle operating apparatus 600 may include a processor. Each unit of the vehicle operating apparatus 600 may individually include a processor.

The power train operating unit 610 may control an operation of a power train device.

The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

For example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may perform a control for a gearbox.

The gearbox operating portion 612 may adjust a state of the gearbox. The gearbox operating portion 612 may change the state of the gearbox into drive (forward) (D), reverse (R), neutral (N) or parking (P).

Meanwhile, when an engine is the power source, the gearbox operating portion 612 may adjust a locked state of a gear in the drive (D) state.

The chassis operating unit 620 may control an operation of a chassis device.

The chassis operating unit 620 may include a steering operating portion 621, a brake operating portion 622 and a suspension operating portion 623.

The steering operating portion 621 may perform an electronic control for a steering apparatus within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

Meanwhile, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road.

Meanwhile, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642 and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating unit 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may operate in an autonomous driving mode.

The operation system 700 may include a driving system 710, a parking exit system 740 and a parking system 750.

According to embodiments, the operation system 700 may further include other components in addition to components to be described, or may not include some of the components to be described.

Meanwhile, the operation system 700 may include a processor. Each unit of the operation system 700 may individually include a processor.

According to embodiments, the operation system may be a sub concept of the controller 170 when it is implemented in a software configuration.

Meanwhile, according to embodiment, the operation system 700 may be a concept including at least one of the user interface apparatus 200, the object detecting apparatus 300, the communication apparatus 400, the vehicle operating apparatus 600 and the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600 and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770, transmit a control signal to the vehicle operating apparatus 600, and park the vehicle 100.

The parking system 750 may receive object information from the object detecting apparatus 300, transmit a control signal to the vehicle operating apparatus 600 and park the vehicle 100.

The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, path information according to the set destination, information regarding various objects on a path, lane information and current location information of the vehicle.

The navigation system 770 may include a memory and a processor. The memory may store the navigation information. The processor may control an operation of the navigation system 770.

According to embodiments, the navigation system 770 may update prestored information by receiving information from an external device through the communication apparatus 400.

According to embodiments, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

Meanwhile, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data. The memory 140 may be a variety of storage devices, such as ROM, RAM, EPROM, a flash drive, a hard drive and the like in a hardware configuration. The memory 140 may store various data for overall operations of the vehicle 100, such as programs for processing or controlling the controller 170.

According to embodiments, the memory 140 may be integrated with the controller 170 or implemented as a sub component of the controller 170.

The controller 170 may control an overall operation of each unit of the vehicle 100. The controller 170 may be referred to as an Electronic Control Unit (ECU).

The power supply unit 190 may supply power required for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

Hereinafter, an electronic control unit 800 loaded or provided in the vehicle 100 will be described in detail.

The electronic control unit 800 is provided in the vehicle 100, and may be implemented as an independent device detachable from the vehicle 100 or as a part of the vehicle 100 which is integrally installed in the vehicle 100.

Hereinafter, for the sake of explanation, description will be given of an example that the electronic control unit 800 is a separate component independent of the controller 170 of the vehicle 100. However, this is only an embodiment of the present invention, and all the operation and control method of the electronic control unit 800 described in this specification may alternatively be performed by the controller 170 of the vehicle 100. That is, the operation and/or control method performed by a processor 830 of the electronic control unit 800 may be performed by the controller 170 of the vehicle 800.

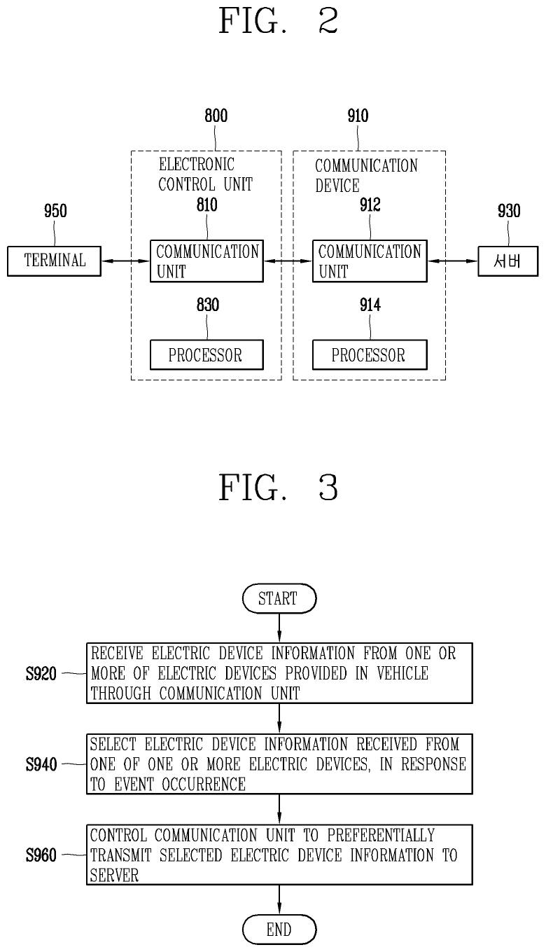

FIG. 2 is a block diagram illustrating an electronic control unit in accordance with an embodiment of the present invention, and FIG. 3 is a flowchart illustrating an operation of the electronic control unit.

Referring to FIG. 2, the electronic control unit 800 includes a communication unit 810 and a processor 830.

The processor 830 receives electric device information from one or more electric devices (or electric components) disposed in the vehicle 100 through the communication unit 810 (S920).

The communication unit 810 is configured to perform communications with the various components described in FIG. 1. Specifically, the communication unit 810 receives electric device information from one or more electric devices provided in the vehicle 100.

Here, the electric device is an electronic device or electronic component provided in the vehicle, and the electric device information refers to information generated by the electric device. For example, a front image captured by a front camera mounted on a front surface of the vehicle 100 corresponds to electric device information related to the front camera, and a rear image captured by a rear camera mounted on a rear surface of the vehicle 100 corresponds to electric device information related to the rear camera.

The communication unit 810 may receive various information provided through a controller area network (CAN). In another example, the communication unit 810 may perform communication with all devices capable of performing communication, such as a vehicle, a mobile terminal, a server, and another vehicle. This may be referred to as Vehicle to everything (V2X) communication. The V2X communication may be defined as a technology of exchanging or sharing information, such as traffic condition and the like, while communicating with a road infrastructure and other vehicles during driving.

The communication unit 810 may receive information related to driving of the vehicle from one or more electric devices provided in the vehicle 100. The electric device information may be referred to as ‘vehicle driving information.’

Vehicle driving information includes vehicle information and surrounding information related to the vehicle. Information related to the inside of the vehicle with respect to the frame of the vehicle 100 may be defined as the vehicle information, and information related to the outside of the vehicle may be defined as the surrounding information.

The vehicle information refers to information related to the vehicle itself. For example, the vehicle information may include a driving speed, a driving direction, an acceleration, an angular velocity, a location (GPS), a weight, a number of passengers in the vehicle, a braking force of the vehicle, a maximum braking force, air pressure of each wheel, a centrifugal force applied to the vehicle, a driving mode of the vehicle (autonomous driving mode or manual driving mode), a parking mode of the vehicle (autonomous parting mode, automatic parking mode, manual parking mode), whether or not a user is present in the vehicle, and information associated with the user.

The surrounding information refers to information related to another object located within a predetermined range around the vehicle, and information related to the outside of the vehicle. The surrounding information of the vehicle may be a state of a road surface on which the vehicle is traveling (e.g., a frictional force), the weather, a distance from a front-side (rear-side) vehicle, a relative speed of a front-side (rear-side) vehicle, a curvature of a curve when a driving lane is the curve, information associated with an object existing in a reference region (predetermined region) based on the vehicle, whether or not an object enters (or leaves) the predetermined region, whether or not the user exists near the vehicle, information associated with the user (for example, whether or not the user is an authenticated user), and the like.

The surrounding information may include ambient brightness, temperature, a position of the sun, information related to nearby subject (a person, another vehicle, a sign, etc.), a type of a driving road surface, a landmark, line information, and driving lane information, and information required for an autonomous driving/autonomous parking/automatic parking/manual parking mode.

In addition, the surrounding information may further include a distance from an object existing around the vehicle to the vehicle 100, collision possibility, a type of an object, a parking space for the vehicle, an object for identifying the parking space (for example, a parking line, a string, another vehicle, a wall, etc.), and the like.

The vehicle driving information is not limited to the example described above and may include all information generated from the components provided in the vehicle 100.

The communication unit 810 transmits electric device information received from an electric device to an external device under the control of the processor 830. Referring to FIG. 2, an external device may be at least one of a communication device 910, a server 930, and a terminal 950. The communication unit 810 may transmit all or some electric device information to the external device sequentially according to a data transmission order.

In response to an event occurrence, the processor 830 selects electric device information received from one of the one or more electric devices (S940).

The processor 830 may select electric device information to be transmitted to the external device and determine the data transmission order.

Specifically, the processor 830 may determine whether or not at least one of a plurality of preset conditions is satisfied, based on vehicle driving information received through the communication unit 810. According to a satisfied condition, the processor 830 may control the communication unit 810 in a different way.

In connection with the preset conditions, the processor 830 may detect an occurrence of an event in an electric device provided in the vehicle 100 and/or application, and determine whether the detected event meets a preset condition. At this time, the processor 830 may detect the occurrence of the event from information received through the communication unit 810.

The application is a concept including a widget, a home launcher, and the like, and refers to all types of programs that can be run on the vehicle 100. Accordingly, the application may be a program that performs a function of a web browser, a video playback, a message transmission/reception, a schedule management, or an application update.

Further, the application may include a forward collision warning (FCW), a blind spot detection (BSD), a lane departure warning (LDW), a pedestrian detection (PD) A Curve Speed Warning (CSW), and a turn-by-turn navigation (TBT).

For example, an event occurrence may correspond to when a failure, breakage, or error occurs in at least one electric device provided in the vehicle 100, when a collision of a predetermined level or more occurs in the vehicle 100, when an accident occurred near the vehicle 100 is detected, when an unlicensed band network such as WiFi is connected to the communication unit 810, or the like.

As another example, the event occurrence may be a missed call, presence of an application to be updated, a message arrival, start on, start off, autonomous driving on/off, pressing of an LCD awake key, an alarm, an incoming call, a missed notification, and the like.

As another example, the occurrence of the event may be a generation of an alert set in the advanced driver assistance system (ADAS), an execution of a function set in the ADAS. For example, the occurrence of the event may be an occurrence of forward collision warning, an occurrence of a blind spot detection, an occurrence of lane departure warning, an occurrence of lane keeping assist warning, or an execution of autonomous emergency braking.

As another example, the occurrence of the event may also be a change from a forward gear to a reverse gear, an occurrence of an acceleration greater than a predetermined value, an occurrence of a deceleration greater than a predetermined value, a change of a power device from an internal combustion engine to a motor, or a change from the motor to the internal combustion engine.

In addition, even when various ECUs provided in the vehicle 100 perform specific functions, it may be determined as the occurrence of the event.

When an occurred event satisfies a preset condition, the processor 830 may select at least one electric device information corresponding to the satisfied condition from among a plurality of electric device information received through the communication unit 810. In other words, the electric device information selected by the processor 830 may be at least one, and may differ depending on an event that has occurred.

For example, the event may be an event that a collision of a reference value or more occurs in the vehicle 100, and the electric device information selected by the processor 830 may vary depending on a collision attribute defined by the collision.

Here, the collision attribute includes at least one of a collision-occurred direction, a collision-occurred position, a collision-occurred degree, a velocity of the vehicle 100 when a collision occurs, a seat type on which a passenger is boarded when a collision occurs, and an object on which a collision has occurred.

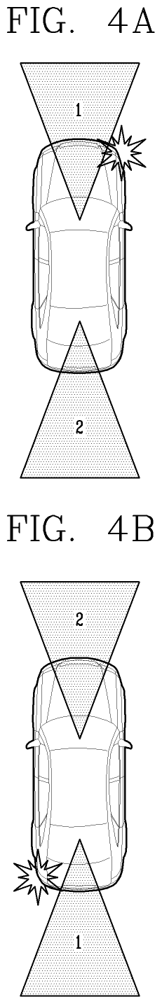

FIGS. 4A and 4B are conceptual views illustrating an embodiment for selecting electric device information to be transmitted to a server due to collision occurred in a vehicle.

The electric devices may include a front camera for generating a front image of the vehicle and a rear camera for generating a rear image of the vehicle. The communication unit 810 receives a front image from the front camera and a rear image from the rear camera.

The processor 830, as illustrated in FIG. 4A, selects the front image when the event occurs, namely, when a forward collision accident has occurred. As illustrated in FIG. 4B, when a rear-end collision accident has occurred as the event, the processor 830 selects the rear image. When both the front and rear collision accidents have occurred within a predetermined time range which may be considered as the same time, both the front image and the rear image may be selected.

Referring back to FIG. 3, the processor 830 controls the communication unit 810 to preferentially transmit the selected electric device information to the server 930 (S960).

The front image may preferentially be transmitted in comparison with the rear image when the front collision accident occurs, and the rear image may preferentially be transmitted in comparison with the front image when the rear-end collision accident occurs.

In order to preferentially transmit the selected electric device information, the processor 830 may perform various operations.

For example, the selected electric device information may be processed such that a preset data transmission order is changed, a transmission priority for each data is set, more usable or available communication bandwidths are assigned to the selected electric device information, or the selected electric device information is preferentially transmitted to the server. Hereinafter, methods for preferentially transmitting selected electric device information will be described in more detail with reference to the accompanying drawings.

In a vehicle environment in which high-capacity data is transmitted and received in real time by a plurality of vehicles, limited frequency resources must be efficiently used and priorities should be set on data to be transmitted and received. Furthermore, communication QoS of data with higher priorities should be guaranteed by efficiently using a limited bandwidth.

Since the electronic control unit 800 according to the present invention transmits data by applying different bandwidths according to priorities, communication quality of service (QoS) of data with higher priorities is guaranteed. Furthermore, because data is classified according to priorities and important data is transmitted first, communication QoS for the important data is ensured. Since data with lower priorities is limited in transmission, frequency efficiency of a network is increased.

Meanwhile, the server 930 may be replaced with an external device of the system including the electronic control unit 800. The external device may include a communication device 910, a server 930, and a terminal 950.

The communication device 910 performs a function of relaying vehicles and a server located in a predetermined area, and may be, for example, a base station. The communication device 910 is a constituent element of a mobile communication system and plays a role of relaying the electronic control unit 800 and the server 930 located in a cell corresponding to a service area. In addition to an interface function between the electronic control unit 800 and the server 930, the communication device 910 controls a cell which is in charge of sending incoming and outgoing signals, designating a call channel, monitoring a call channel, self-diagnosis, and the like.

The server 930 provides various contents such as a map and the like to the electronic control unit 800 through the communication device 910 and controls and manages the vehicle 100 through the electronic control unit 800.

The terminal 950 is carried by a passenger boarding the vehicle 100 and refers to a mobile terminal such as a smart phone or a notebook computer. The terminal 950 may provide an unlicensed band network such as WIFI to the electronic control unit 800 using a communication bandwidth allocated thereto. The terminal 950 may alternatively use an unlicensed band network provided by the electronic control unit 800. In this case, the terminal 950 occupies a part of a communication bandwidth allocated to the electronic control unit 800.

Each device included in the system must efficiently use limited frequency resources. Hereinafter, operations of the electronic control unit 800 and/or the communication device 910 for efficiently using its and/or their own frequency resources will be described in detail.

First, the operation of the electronic control unit 800 will be described in more detail.

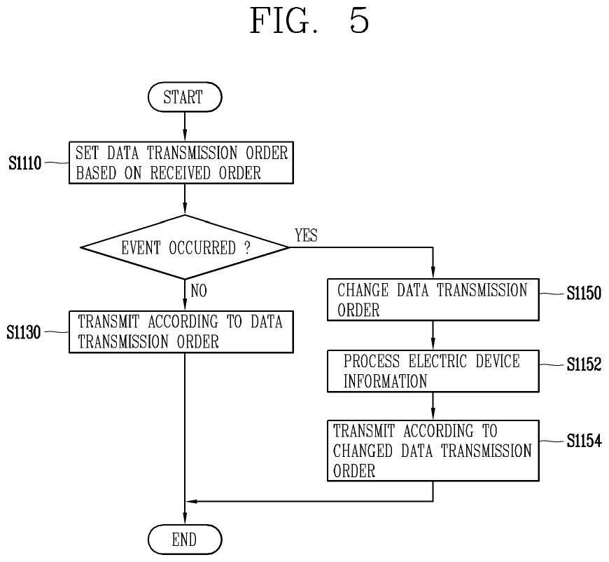

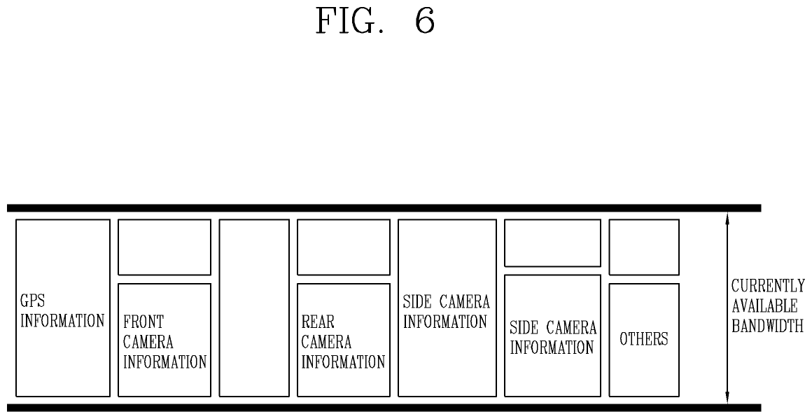

FIG. 5 is a flowchart illustrating a method in which an electronic control unit changes a data transmission order of electric device information to be transmitted to a server in accordance with an embodiment of the present invention, and FIG. 6 is a conceptual view illustrating processing of electric device information in the method of FIG. 5.

The processor 830 sets a data transmission order based on a reception order of data received through the communication unit 810 and/or a data size (S1110). For example, the processor 830 may set a data transmission order in a first-in first-out (FIFO) manner in which information received first is transmitted first, or set the data transmission order according to a sequence of data which is completely transmitted fast due to a small size of the data.

If an event does not occur, the processor 830 sequentially transmits electric device information according to the data transmission order (S1130).

When an event occurs, the processor 830 changes the data transmission order (S1150), and transmits the electric device information according to the changed data transmission order (S1154). In other words, the processor 830 changes the data transmission order, which has been set before the event occurs, in response to the occurrence of the event, and sequentially transmits the electric device information received from the one or more electric devices according to the changed data transmission order.

The change of the data transmission order may be made differently according to an event occurrence order and according to a type of received electric device information.

If no event has occurred, all electric device information to be transmitted is transmitted to the server according to a first method. On the other hand, when an event has occurred, all or part of electric device information is transmitted to the server according to a second method different from the first method.

The processor 830 may process the electric device information received from the one or more electric devices before transmitting the electric device information to the server 930 according to the changed data transmission order. The processor 830 processes the electric device information received from the one or more electric devices based on the changed data transfer order.

As illustrated in FIG. 6, when a predetermined event occurs, regardless of a received order, the processor 830 may decide the data transmission order as “GPS information, front camera information, rear camera information, side camera information and others”, based on the predetermined event.

The processor 830 determines whether or not to process each electric device information and a processing method according to the data transmission order. For example, “front camera information” is divided into three parts according to a bandwidth, but “others” may not be processed.

The processing method includes various methods such as division/compression/editing.

The processor 830 divides electric device information into at least two pieces of data based on a bandwidth that the communication unit 810 can use, and transmits the divided pieces of data to the server 930 at different points of time. That is, the processor 830 divides each electric device information to be suitable for bandwidths so that all bandwidths are used.

For example, a size of the remaining part, except for a part for GPS information, of an entire bandwidth is calculated and a part of the front camera information corresponding to the remaining part is extracted, so that the part of the GPS information and the part of the front camera information can be simultaneously transmitted to the server 930. The extracted part of the front camera information is transmitted to the server 930 together with the part of the GPS information.

The processor 830 may process electric device information according to a bandwidth available by the communication unit 810, that is, an amount of data to be transmitted per unit time.

The processor 830 calculates a compression requirement time required for compressing electric device information, a post-compression transmission requirement time which is required for transmitting compressed data after the compression, and a pre-compression transmission requirement time which is required for transmitting uncompressed data. When the pre-compression transmission requirement time is greater than the sum of the compression requirement time and the post-compression transmission requirement time, the processor 830 compresses electric device information.

The processor 830 may classify information included in electric device information into a first group and a second group based on an occurred event. Information related to an event is included in the first group and information irrelevant to the event is classified into the second group. A type of classified information varies depending on an occurred event. When the information classified into the second group is included in the electric device information, the processor 830 may delete the information classified into the second group through editing, or may selectively transmit only the information classified into the first group to the server 930 without deleting the information classified into the second group. That is, the information classified into the second group is not transmitted to the server 930.

The processor 830 may process data according to the available bandwidth of the communication unit 810, thereby efficiently using the bandwidth of the communication unit 810.

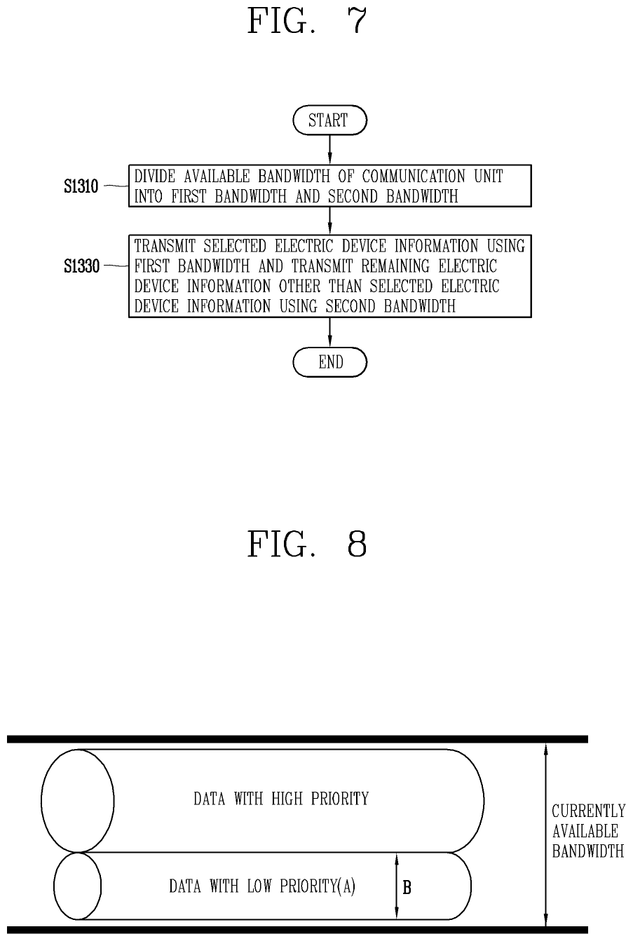

FIG. 7 is a flowchart illustrating a method in which an electronic control unit divides an available bandwidth and independently uses the divided bandwidths in accordance with an embodiment of the present invention, and FIG. 8 is a conceptual view illustrating the method of FIG. 7 in detail.

Referring to FIG. 7, the processor 830 may divide an available bandwidth of the communication unit 810 into a first bandwidth and a second bandwidth (S1310).

Next, selected electric device information is transmitted using the first bandwidth, and the remaining electric device information other than the selected electric device information may be transmitted using the second bandwidth (S1330). By controlling the bandwidth allocated for each data, it is possible to transmit data according to priorities.

The second bandwidth may be used to receive data as well as to transmit data. Transmission of one electric device information (or electric device information selected by the processor) with the highest priority can fast be transmitted using the first bandwidth, and here a partial bandwidth (or the second bandwidth) of the communication unit 810 may be left to be used for other communications.

The first bandwidth may be set to be larger than the second bandwidth.

As the first and second bandwidths are divided, a first electric device may be allocated to the first bandwidth, and a second electric device different from the first electric device may be allocated to the second bandwidth. In this case, the first electric device may perform communication using the first bandwidth, and the second electric device may perform communication using the second bandwidth.

The second bandwidth allows a limited use of a communication frequency, and functions of the second electric device to be executed while using the second bandwidth may be limited. For example, when the second electric device is a multimedia playback device, at least one of the first bandwidth and the second bandwidth may vary according to various conditions.

For example, the processor 830 may variably set at least one of the first bandwidth and the second bandwidth according to electric device information to be transmitted through the first bandwidth.

Specifically, a time point at which transmission of predetermined electric device information should be completed may be preset according to an event occurrence or may be determined in real time by the processor 830. The processor 830 adjusts a size of the first bandwidth so that the transmission of the predetermined electric device information is completed within the time point. When the time point is earlier, the first bandwidth becomes larger and the second bandwidth becomes smaller.

The processor 830 can improve efficiency of data transmission by variably adjusting the first and second bandwidths according to an event or electric device information to be transmitted.

In another example, the processor 830 may variably set at least one of the first bandwidth and the second bandwidth depending on whether the communication unit 810 is connected to an unlicensed band network.

For example, a terminal 950 carried by a passenger boarding the vehicle 100 may provide an unlicensed band network according to the request of the passenger. It is an example in which Wi-Fi is provided through a hotspot, and the like, and the communication unit 810 is connected to the Wi-Fi.

When the unlicensed band network is connected in a state where the first and second bandwidths have been set, the processor 830 may reset at least one of the first bandwidth and the second bandwidth.

For example, first electric device information may be transmitted through a first bandwidth of a first size, and second electric device information may be transmitted through a second bandwidth of a second size. When an unlicensed band network is connected during the transmission of the first and second electric device information, the processor 830 may remove the second bandwidth and transmit the first electric device information through an entire bandwidth of the communication unit 810. And the second electric device information is transmitted through the unlicensed band network.

The processor 830 controls the communication unit 810 in such a manner that electric device information with low priority is transmitted to the server 930 through the unlicensed band network, in response to being connected to the unlicensed band network.

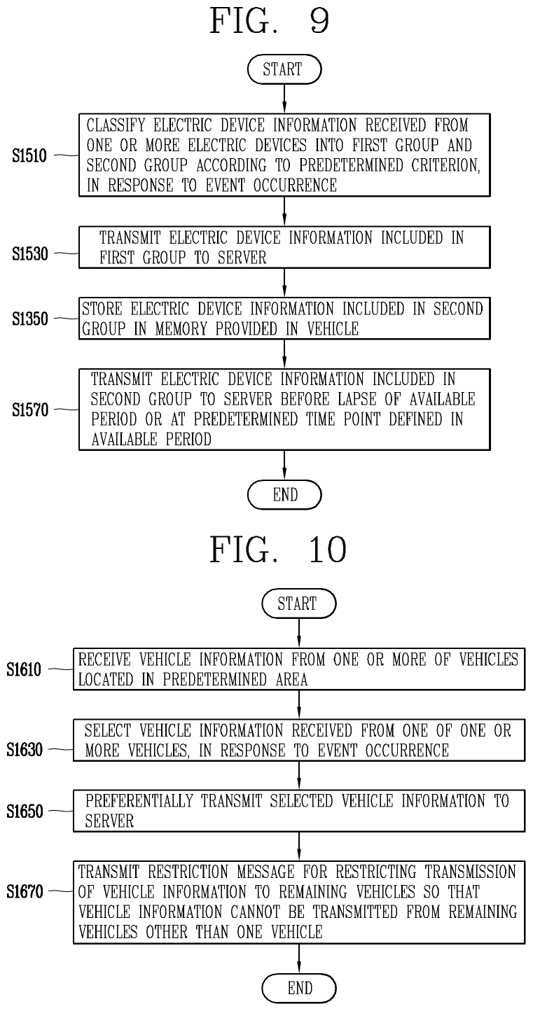

FIG. 9 is a flowchart illustrating a method in which an electric control unit preferentially transmits electric device information in accordance with an embodiment of the present invention.

The processor 830 classifies electric device information received from one or more electric devices into a first group and a second group according to a predetermined criterion, in response to an event occurrence (S1510).

The predetermined criterion may vary according to an occurred event. For example, a first criterion may be applied when a first event occurs, and a second criterion may be applied when a second event occurs.

Next, the processor 830 transmits the electric device information included in the first group to the server 930 (S1530), and stores the electric device information included in the second group in a memory provided in the vehicle 100 (S1550). In other words, the electric device information included in the first group is transmitted to the server 930, but the electric device information included in the second group is stored in the memory without being transmitted to the server 930.

Next, the processor 830 transmits the electric device information included in the second group to the server 830 before a lapse of an available period or at a predetermined time point defined in the available period (S1570).

The processor 830 sets the available period in the electric device information included in the second group. More specifically, when the electric device information included in the second group is stored in the memory, the available period may be added as metadata or the like.

The available period may be set differently depending on an event occurred and/or a file size of electric device information selected by the processor 830 in response to an event occurrence.

The processor 830 controls the communication unit 810 so that the electric device information included in the second group is transmitted to the server before the lapse of the available period or at the predetermined time point defined in the available period. In other words, the processor 830 stores data with lower priorities in the memory, and then transmits such data with the lower priorities in a situation where there is left a less amount of data occupying the bandwidth after data with higher priorities is all transmitted.

The electric device information included in the second group may be deleted from the memory before the lapse of the available period or at the predetermined time point defined in the available period. When the transmission is completed, the electric device information included in the second group is deleted.

Since some of information to be transmitted are not transmitted but stored in the memory, communication resources can be used efficiently. Also, since an available period is set in the information stored in the memory, memory resources can also be used efficiently.

Meanwhile, the present invention provides a communication device 910 for relaying vehicles and a server located in a predetermined area. As the number of services using high-capacity data increases, the communication device 910 must also use communication resources efficiently for the same reason as the electronic control unit 800.

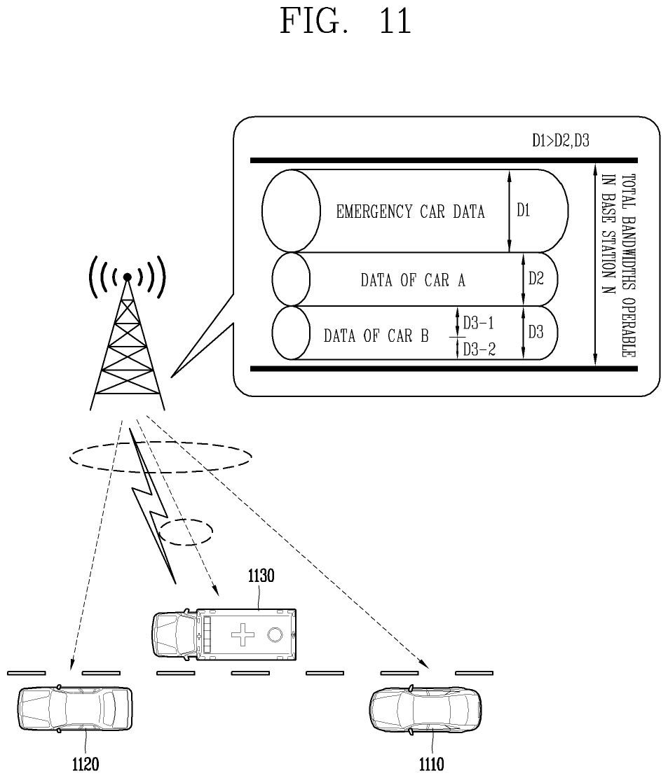

FIG. 10 is a flowchart illustrating an operation of a communication device for relaying vehicles and a server located in a predetermined area, and FIG. 11 is a conceptual view illustrating the operation of FIG. 10 in detail.

Referring to FIG. 2, the communication device 910 includes a communication unit 912 and a processor 914.

The communication unit 912 receives vehicle information from at least one of vehicles located in a predetermined area (S1610), and transmits the received vehicle information to the server 930.

The vehicle information may be information transmitted by the electronic control unit 800. That is, the vehicle information is information that is generated by at least one of a plurality of electric devices provided in the vehicle. Information which is received by the communication unit 912 from the electronic control unit 800 is defined as the vehicle information.

For example, the vehicle information may include images captured by cameras mounted on the vehicle, moving object information sensed by the vehicle, traffic light information, lane information, accident information, and the like.

The processor 914 performs communication frequency allocation, communication channel designation, and the like for vehicles located in the predetermined area. The predetermined area may be referred to as a ‘cell’ managed by the communication device 910.

Referring to FIG. 10, the processor 914 selects vehicle information received from any one of the at least one vehicle in response to an occurrence of an event (S1630).

The event is that emergency information should be propagated (notified) to vehicles located in the predetermined area, and various accidents may be defined as the event according to embodiments.

The event may correspond to that an accident has occurred in the predetermined area, an emergency vehicle satisfying a reference condition enters the predetermined area, or a vehicle located within the predetermined area changes to the emergency vehicle satisfying the reference condition.

For example, a first vehicle located in the predetermined area may transmit accident information occurred therein to the communication device 910. Or the first vehicle senses an accident of a second vehicle and transmits the accident information occurred in the second vehicle to the communication device 910. The accident information may include a location of an accident vehicle, a kind of accident, a video image of the accident vehicle, and the like. The processor 914 may determine that the event has occurred when the accident information is received and perform an operation accordingly. In response to the event that the accident information is received, the processor 914 may select the accident information.

When the occurred event satisfies a preset condition, the processor 914 may select at least one of a plurality of vehicle information received through the communication unit 912 as vehicle information corresponding to the satisfied condition. In other words, the vehicle information selected by the processor 914 may be one or more, and may vary depending on an event that have occurred.

Next, the processor 914 preferentially transmits the selected vehicle information to the server 930 (S1650).

The processor 914 may select vehicle information to be transmitted to the server 930 and determine a data transmission order to transmit the vehicle information.

Specifically, the processor 914 may determine whether or not at least one of a plurality of preset conditions is satisfied, based on vehicle information received through the communication unit 912. According to a satisfied condition, the processor 914 may control the communication unit 912 in a different way.

When the event corresponds to that an emergency vehicle satisfying a reference condition enters the predetermined area or that one vehicle located in the predetermined area is changed to the emergency vehicle satisfying the reference condition, the processor 914 may control the communication unit 912 so that vehicle information received from the emergency vehicle is preferentially transmitted to the server 930.

As an example of an operation according to an event occurrence, the processor 914 changes a data transmission order set before the event has occurred, in response to the event occurrence, and sequentially transmits vehicle information received from the at least one vehicle according to the changed data transmission order. At this time, the highest priority is set for the selected vehicle information, and the selected vehicle information is preferentially transmitted to the server 930.

This is to preferentially transmit information related to an accident vehicle to the server 930 so that processing related to the accident can be performed quickly in the server 930. In another example, the processor 914 may divide the available bandwidth of the communication unit 912 into a first bandwidth and a second bandwidth, assign the first bandwidth to one of the at least one vehicle and the second bandwidth to the remaining vehicles other than the one vehicle.

As illustrated in FIG. 11, a first vehicle 1110, a second vehicle 1120, and a third vehicle 1130 may be located in a predetermined area. The first vehicle 1110 may transmit first vehicle information, the second vehicle 1120 may transmit second vehicle information, and the third vehicle 1130 may transmit third vehicle information to the communication device 900.

The processor 914 may allocate a bandwidth to each of the first to third vehicles 1110 to 1130. For example, a first bandwidth D2 may be allocated a first bandwidth D2, the second vehicle may be allocated with a second bandwidth D3 and the third vehicle may be allocated with a third bandwidth D1. If an event does not occur, a bandwidth of the same size may be allocated to each vehicle, or a bandwidth of a different size may be allocated to each vehicle depending on an amount of data to be transmitted and received with each vehicle.

If the third vehicle 1130 corresponds to an emergency vehicle satisfying the reference condition, the processor 914 reallocates the first to third bandwidths D2, D3 and D1 so that vehicle information transmitted from the third vehicle 1130 is preferentially transmitted to the server 930. At this time, the third bandwidth D3 is larger than the first bandwidth D1 and reallocated in a manner of being larger than the second bandwidth D2.

A larger bandwidth is allocated to the emergency vehicle in order to preferentially transmit the vehicle information generated by the emergency vehicle, compared to other vehicles.

Next, the processor 914 may transmit a restriction message for restricting transmission of vehicle information to the remaining vehicles, so that vehicle information cannot be transmitted from other vehicles except for the one vehicle which has transmitted the selected vehicle information (S1670).

This is for limiting or blocking the information transmission of the vehicles located in the predetermined area so that an amount of information transmitted to the communication device 910 can be reduced. By increasing a bandwidth of an emergency vehicle such as an emergency car or a police car and restricting data transmission of other vehicles except for the emergency vehicle, communication QoS of a vehicle which transmits and receives data with higher priorities can be ensured.

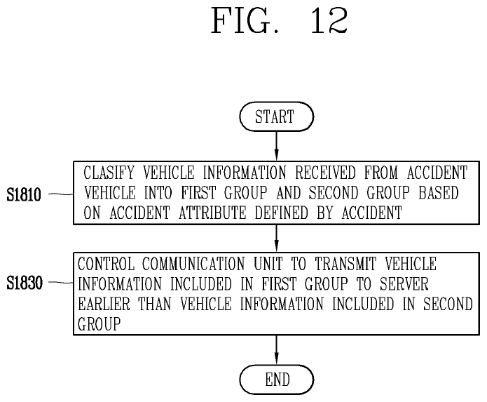

FIG. 12 is a flowchart illustrating a method of controlling a communication device in accordance with an embodiment of the present invention.

The processor 914 may classify vehicle information received from an accident vehicle into a first group and a second group based on an accident attribute defined by the accident (S1810).

Next, the processor 914 controls the communication unit 912 to transmit the vehicle information included in the first group to the server 930 earlier than the vehicle information included in the second group (S1830).

In the accident vehicle that satisfies the reference condition, the reference condition may correspond to that an accident has occurred in a vehicle located in the predetermined area. In this case, the processor 914 may classify the vehicle information received from the accident vehicle into a first group and a second group based on the accident attribute defined by the accident, and control the communication unit 912 so that the vehicle information included in the first group can be transmitted more quickly than the vehicle information included in the second group.

This is for selecting some information having higher importance, of information transmitted from the accident vehicle, and preferentially transmitting the selected information to the server 930 earlier than the other information, instead of preferentially transmitting all of the information transmitted from the accident vehicle to the server 930.

For example, a vehicle in which a front collision accident has occurred may transmit a front image captured by a front camera and a rear image captured by a rear camera to the communication device 910. At this time, the processor 914 may classify the front image into a first group and the rear image into a second group, and transmit the front image to the server 930 earlier than the rear image.

According to the present invention, since data with higher priority is preferentially transmitted, a new effect is obtained in which communication QoS of a vehicle and communication QoS of the communication device are all improved.

Meanwhile, the present invention may extend even to a vehicle 100 having the electronic control unit 800 described with reference to FIGS. 8 to 15. Further, operations of the electronic control unit 800 may be installed as applications or programs in a system within the vehicle 100 so as to be extended to a control method performed by the controller 170 of the vehicle 100.

The present invention can be implemented as computer-readable codes (applications or software) in a program-recorded medium. The method of controlling the autonomous vehicle can be realized by a code stored in a memory or the like.

The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the processor or the controller. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

What is claimed is:

1. A control apparatus of a vehicle, comprising:
a communication device configured to receive electric device information from one or more of electric devices of the vehicle; and
a processor connected to the communication device and configured to:
obtain the received electric device information from the communication device;
select electric device information received from one of the one or more electric devices based on an occurrence of an event; and
control the communication device to transmit, to a server, the selected electric device information.

2. The control apparatus of claim 1, wherein the selected electric device information varies according to occurrence of different events.

3. The control apparatus of claim 2,
wherein the event is a collision of the vehicle,
wherein the occurrence of the event is determined based on a severity level of the collision of the vehicle being equal to or higher than a reference value, and
wherein the selected electric device information varies according to one or more collision attributes of the collision.

4. The control apparatus of claim 3, wherein the electric devices include a front camera configured to generate a front image of the vehicle and a rear camera configured to generate a rear image of the vehicle,
wherein the processor is further configured to select the front image of the vehicle based on an occurrence of a front collision accident of the vehicle and control the communication device to transmit the selected front image of the vehicle to the server, and
wherein the processor is further configured to select the rear image of the vehicle based on an occurrence of a rear collision accident of the vehicle, and control the communication device to transmit the selected rear image of the vehicle to the server.

5. The control apparatus of claim 1,
wherein the processor is further configured to change a data transmission order of the electric device information according to the occurrence of the event, and
wherein the processor is further configured to control the communication device to sequentially transmit the received electric device information in the changed data transmission order.

6. The control apparatus of claim 5, wherein the processor is further configured to process the received electric device information based on the changed data transmission order.

7. The control apparatus of claim 6, wherein the processor is further configured to divide the selected electric device information into at least two pieces of data based on an available bandwidth of the communication device, and control the communication device to transmit the divided pieces of data to the server at different time periods.

8. The control apparatus of claim 1,
wherein the processor is further configured to divide an available bandwidth of the communication device into a first bandwidth and a second bandwidth, and
wherein the processor is further configured to control the communication device to transmit the selected electric device information using the first bandwidth, and to transmit a remainder of the obtained electric device information using the second bandwidth.

9. The control apparatus of claim 8, wherein the first bandwidth is larger than the second bandwidth.

10. The control apparatus of claim 8, wherein completion of transmitting the selected electric device information, through the divided first bandwidth of the communication device, is equal to or earlier than a preset time point.

11. The control apparatus of claim 8, wherein the processor is further configured to stop dividing the available bandwidth of the communication device based on the communication device being connected to an additional network with available bandwidth.

12. The control apparatus of claim 11, wherein the processor is further configured to control the communication device to:
transmit the selected electric device information through the available bandwidth of the communication device; and
transmit the remainder of the obtained electric device information to the server through the available bandwidth of the additional network.

13. The control apparatus of claim 1, wherein the processor is further configured to classify the selected electric device information into a first group and a second group according to a predetermined criterion,
wherein the processor is further configured to control the communication device to transmit the electric device information of the first group to the server, and
wherein the processor is further configured to store the electric device information of the second group in a memory of the vehicle.

14. The control apparatus of claim 13, wherein the electric device information of the second group has a set available period, and
wherein the processor is further configured to control the communication device to transmit the electric device information of the second group to the server before a lapse of the available period or a predetermined time point defined in the available period.

15. A communication apparatus configured to relay information between vehicles and a server located in a predetermined area, the communication apparatus comprising:
a communication device configured to receive vehicle information from one or more vehicles located in the predetermined area; and
a processor connected to the communication device and configured to:
select vehicle information received from one of the one or more vehicles based on an occurrence of an event; and
control the communication device to transmit, to the server, the selected vehicle information.

16. The communication apparatus of claim 15, wherein the occurrence of the event is determined based on a vehicle with an emergency status entering the predetermined area, or a vehicle located within the predetermined area changing to an emergency status, and
wherein the processor is further configured to control the communication device to transmit, to the server, vehicle information received from the vehicle with an emergency status.

17. The communication apparatus of claim 16, wherein the emergency status includes a vehicle accident, and
wherein the processor is further configured to classify the vehicle information received from the vehicle with an emergency status into a first group and a second group based on a severity level of the emergency status, and to control the communication device to transmit the vehicle information of the first group.

18. The communication apparatus of claim 15, wherein the processor is further configured to:
divide an available bandwidth of the communication device into a first bandwidth and a second bandwidth;
allocate the first bandwidth to the one of the one or more vehicles; and
allocate the second bandwidth to a remainder of the one or more vehicles.

19. The communication apparatus of claim 18, wherein the processor is further configured to transmit a restriction message to the remainder of the one or more vehicles, and to limit transmission, to the server, of vehicle information from the remainder of the one or more vehicles.

20. The communication apparatus of claim 15, wherein the processor is further configured to change a data transmission order of the received vehicle information, and to sequentially transmit the received vehicle information in the changed data transmission order.
